(19) United States
(12) Patent Application Publication
(10) Pub. No.: US 2002/0082846 A1
(43) Pub. Date: Jun. 27, 2002

(54) Method and system for generating quality control testing procedures

(76) Inventors: Ming-Chih Chang, Taipei (TW); Lan-Gang Chin, Taipei (TW); Pao-Chih Fan, Taipei (TW)

Correspondence Address: NAIPO (NORTH AMERICA INTERNATIONAL PATENT OFFICE), P.O. BOX 506, MERRIFIELD, VA, 22116, US

(21) Appl. No.: 09/740,889

(22) Filed: Dec. 21, 2000

(51) Int. Cl. G06F 17/60

(52) U.S. Cl. 705/1

(57) ABSTRACT

A test plan has a tree-like structure, which has a top level for identifying the test plan, an intermediate level with test report files, and a lower level with test item files. The test item files have testing steps for performing a test of an item. The top level is used to access the test report files of the test plan, and each test report file is used to access test item files. A template archive is provided that holds complete test plan templates for use as a reference. A selection system enables a user to select a template from the template archive, and then hierarchically select template test report files, and template test item files under each template test report file. A conversion system then converts the hierarchical selection into a corresponding test plan.

### BACKGROUND OF THE INVENTION

1. Field of the Invention

The present invention relates to quality control testing procedures. More specifically, the present invention discloses a method and system for generating quality control testing procedures from a database.

2. Description of the Prior Art

Product reliability is essential for any manufacturer that cares about keeping market share. Customers are far more willing to buy a product when they know that the product comes from a company with a good record for offering high-quality products. To ensure the quality, then, of their products, manufacturers must have comprehensive quality control procedures.

A new product is typically tested throughout its development cycle. A large number of tests, especially for electronic goods, must be performed on the product, such as hardware and software compatibility tests, stress tests, environment tests, etc. Typically, quality assurance personnel must custom design the testing procedures for each product. When designing such testing procedures, it is essential that all relevant tests are incorporated, and that nothing is “left out” or forgotten. Generally, the head of the department, having many years of related experience upon which to draw, will oversee the test plans to make certain that they are comprehensive. This requires referencing the test plans of a similar, previous product, and tailoring them to the new product. Such a process is unnecessarily time-consuming, as quality control personnel repetitively reinvent nearly identical test plans for nearly identical products. The process is also error-prone as key tests may be missed due to a lack of insufficient documentation of tests done on the earlier product.

### SUMMARY OF THE INVENTION

It is therefore a primary objective of this invention to provide a system and method for generating the test plans of a quality control procedure for a product.

The present invention, briefly summarized, discloses a method and related system for generating a test plan for a quality control procedure. The test plan has a tree-like structure, which has a top level for identifying the test plan, an intermediate level with test report files, and a lower level with test item files. The test item files have testing steps for performing a test of an item. The top level is used to access the test report files of the test plan, and each test report file is used to access test item files. A template archive is provided that holds complete test plan templates for use as a reference. A selection system enables a user to select a template from the template archive, and then hierarchically select template test report files, and template test item files under each template test report file. A conversion system then converts the hierarchical selection into a corresponding test plan.

It is an advantage of the present invention that the template archive acts as an information warehouse, storing complete test plans rigorously built up over time. These comprehensive test plans can be quickly and conveniently accessed, and their relevant pieces selected and copied to create a new test plan. This speeds up the entire test plan design time, and helps to ensure that no required tests in a new test plan are forgotten or accidentally left out.

These and other objectives of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a block diagram of the structure of a quality control test plan according to the present invention.

FIG. 2 is a partial block diagram of a hypothetical test plan according to the present invention.

FIG. 3 illustrates the contents of a test item file according to the present invention.

FIG. 4 illustrates the contents of a test report file according to the present invention.

FIG. 5 is a block diagram of a template archive according to the present invention.

FIG. 6 is depicts a browser of the present invention being used to browse a template archive of the present invention.

FIG. 7 is a flow chart for a conversion system of the present invention. FIG. 8 is a block diagram of a new test plan made according to the present invention.

FIG. 9 is a block diagram of a computer system that is used to implement the present invention.

### DETAILED DESCRIPTION OF THE PREFERRED EMBODIMENT

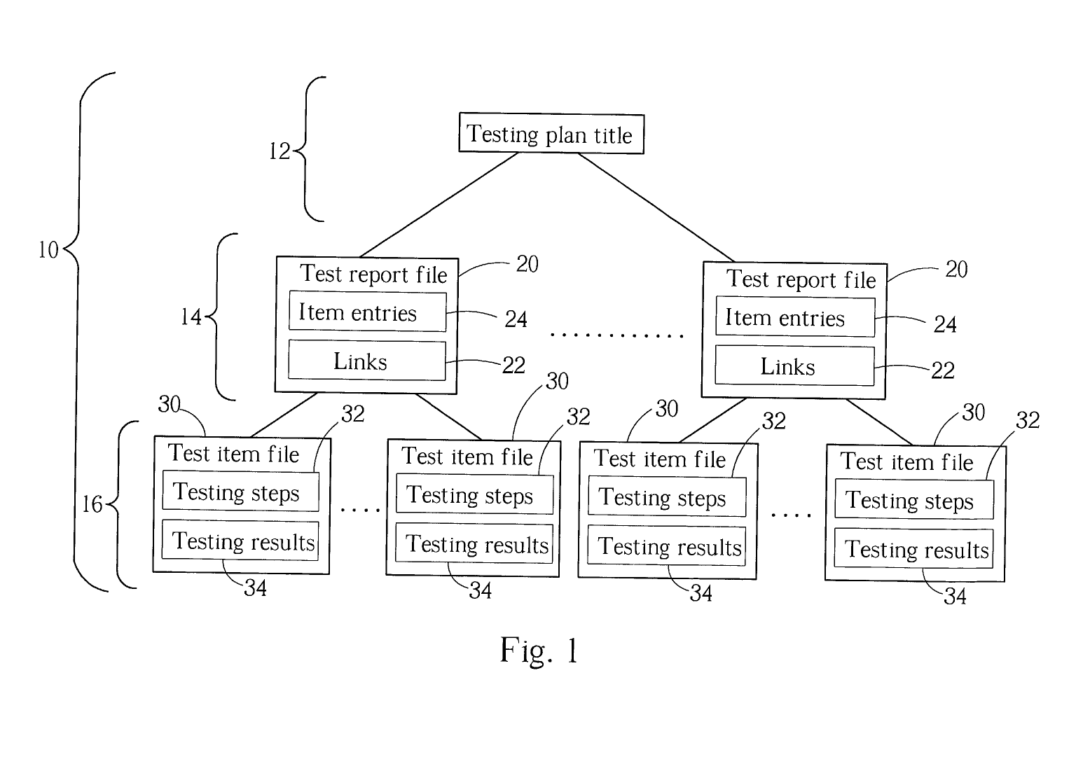

Please refer to FIG. 1. FIG. 1 is a block diagram of the structure of a quality control test plan 10 according to the present invention. The test plan 10 has a tree-like structure, with a top level 12, an intermediate level 14 and a lower level 16, and is tailored for the quality control testing procedures required to test a product (not shown). The top level 12 is used to title the test plan 10, and to reference the intermediate level 14. The intermediate level 14 comprises a series of test report files 20. Each test report file 20 deals with a particular area that must be tested, and together all of the test report files 20 cover all of the areas that need to be tested to insure the quality of the product. Each test report file 20 is used to reference one or more test item files 30 in the lower level 16. Each test item file 30 is used to test a specific aspect of the area of interest of the parent test report file 20. The test item files 30 each contain testing steps 32 that are required to be performed to test the related specific aspect of the product, and testing result entries 34 that are filled in by testing personnel to report on the results of the specific test.

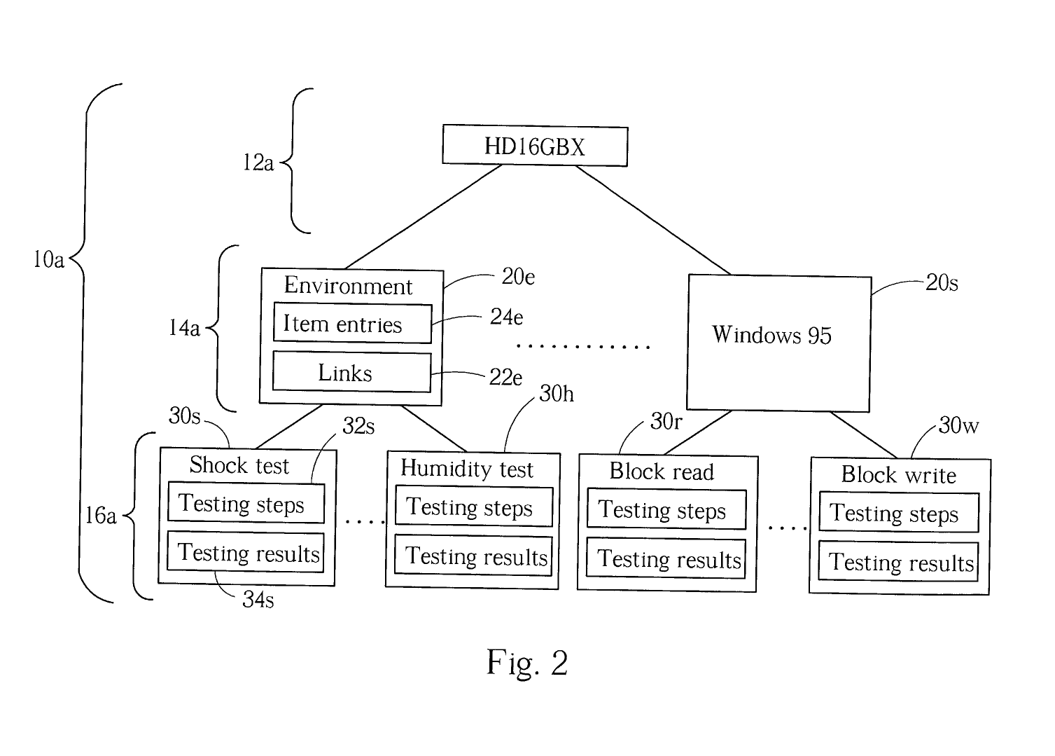

To better understand the architecture of the test plan 10, please refer to FIG. 2 in conjunction with FIG. 1. FIG. 2 is a partial block diagram of a hypothetical test plan 10a. The hypothetical test plan 10a is for a hard disk drive, and is entitled “HD16GBX”, at the upper level 12a. The upper level 12a is used to access the intermediate level 14a. The intermediate level 14a has test report files 20e and 20s. Of course, numerous areas must be covered to fully test the hard disk “HD16GBX”, and thus there would be numerous test report files in the intermediate level 14a. For simplicity, only two test report files 20e and 20s are shown: the “Environment” test report file 20e, and the “Windows95” test report file 20s. The “Environment” test report file 20e is used to access various test item files in the lower level 16a, and these test item files under the test report file 20e are each concerned with testing a particular aspect of the hard disk HD16GBX under a certain environmental condition. For example, the test item file 30s deals with testing procedures that are to be carried out to test the performance of the hard disk HD16GBX under sudden, severe, accelerations. The test item file 30h deals with checking the performance of the hard disk drive HD16GBX under conditions of abnormally high humidity. Similarly, the “Windows95” test report file 20s is used to test an operating system driver for the hard disk HD16GBX. Various specific tests must be performed to verify that the operating system driver works properly with both the operating system and the hard disk HD16GBX, such as a block read test 30r and a block write test 30w.

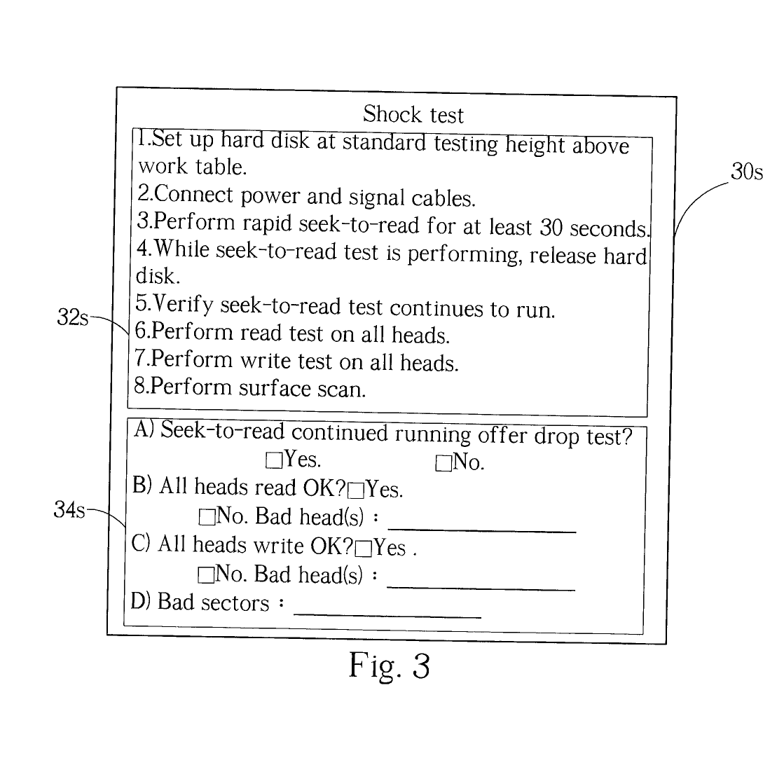

Each of the test item files 30 will contain the steps that must be performed to satisfy the specific test in question. For example, the “Shock test” test item file 30s holds testing steps 32s that are performed by the testing personnel on the hard disk drive HD16GBX to verify that the hard disk drive HD16GBX satisfactorily survives certain, minimum accelerations. Please refer to FIG. 3. FIG. 3 illustrates the possible contents of the test item file 30s. Such contents are not to be taken literally, but are intended only to illustrate the purpose of the test item files 30. The test item file 30s contains the steps 32s that are to be performed to do the shock test, such as powering up the hard disk HD16GBX and then performing repeated seeking operations, dropping the hard disk from a small height onto a work bench, verifying the status of the read/write heads, etc. After the steps 32s are completed, or as they are being performed, the results can be recorded in the testing results entries 34s.

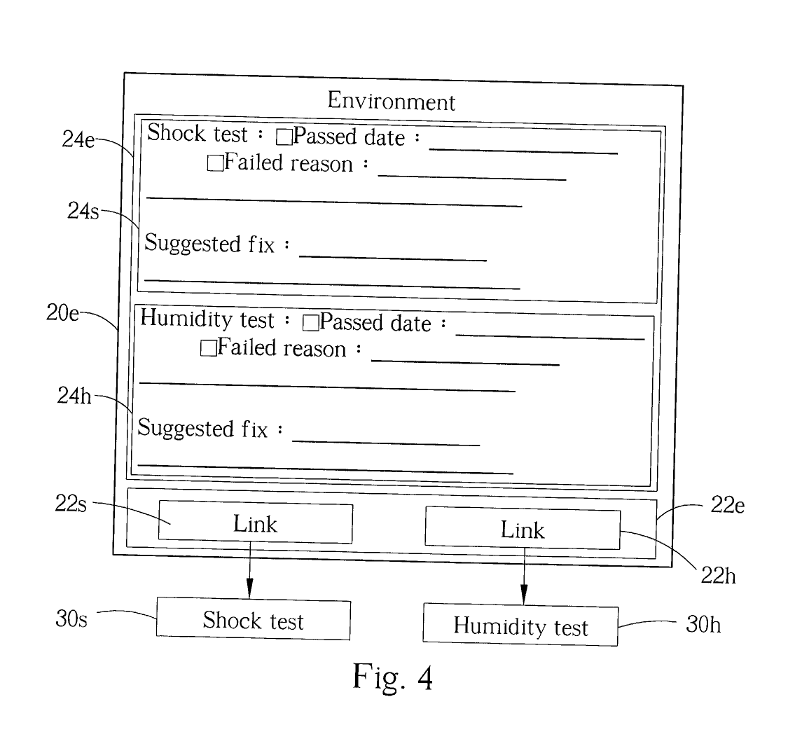

Please refer to FIG. 4 in conjunction with FIGS. 1 and 2. FIG. 4 illustrates the possible contents of the test report file 20e. Each test report file 20 is used to access appropriate test item files 30. This is performed by incorporating links 22 for the test item files 30 into the appropriate test report file 20. For example, the test report file 20e contains links 22s and 22h. Link 22s references the test item file 30s, and link 22h references the test item file 30h. Of course, any number of links is possible, but there should be at least one link as a test report file 20 without any associated test item files 30 has no real purpose. The test report files 20 may have item entries 24 for each associated test item file 30.

These item entries 24 are filled in by test personnel to indicate the status of each test item file 30 under the test report file 20. For example, the test report file 24e has item entries 24s for the test item file 30s, and 24h for test item file 30h. In this manner, each test report file 20 holds a testing summary in the item entries 24 so that testing personnel, by viewing the test report files 20, can obtain a quick overview of the progress of a testing procedure for the product.

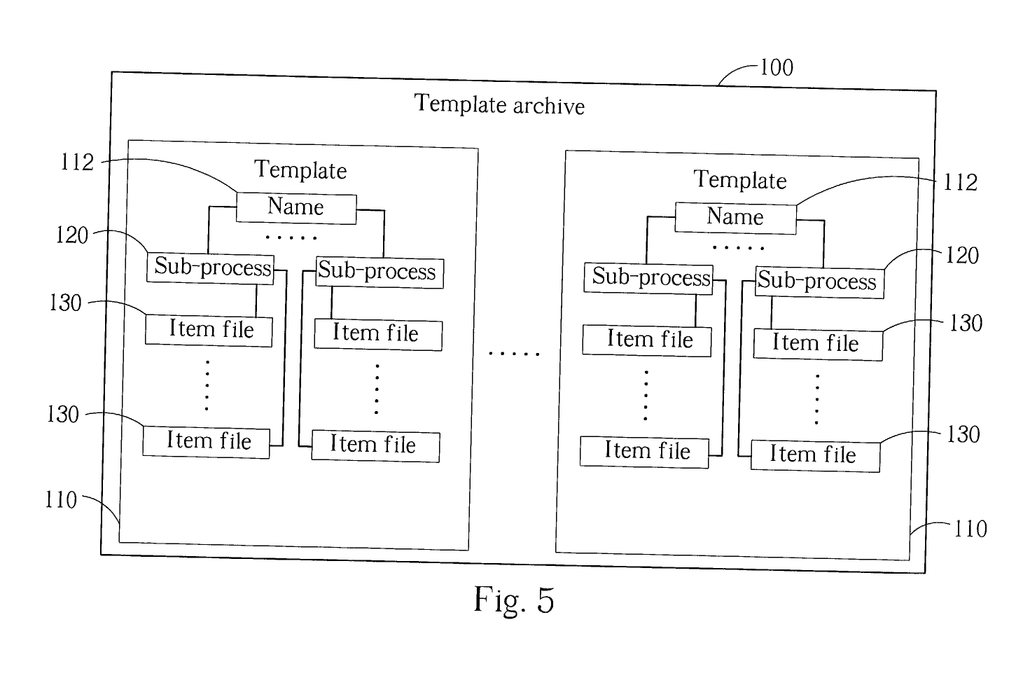

To obtain the objectives of this invention, a test plan template archive is required. Please refer to FIG. 5. FIG. 5 is a block diagram of a test plan template archive 100 according to the present invention. The template archive 100 is used to hold a plurality of test plan templates 110. Each test plan template 110 is a complete test plan for a product. In structure, the test plan templates 110 are almost identical to that of the test plan 10 of FIG. 1. Each test plan template 110 has tree-like structure with a name 112 that is used to identify the test plan template 110, and to thus reference sub-processes 120 in the test plan template 110. The sub-processes 120 are similar to the test report files 20 of FIG. 1, but, as they are part of an overall database 100, they do not need to be separate files. Instead, each of the sub-processes 120 is used to reference at least one item file 130. The item files 130 correspond exactly to the test item files 30 of FIG. 1. The item files 130 hold detailed testing steps that need to be carried out to perform a specific test on the product of the test plan 110, and also have entries to be filled out by the testing personnel. The test plan template archive 100 represents a substantial warehousing of test plan knowledge, gathered over time by actually performing quality control tests on a product. Each test plan 110 should be as complete and as accurate as possible for the product in question, but blank in the sense that no actual test data should be entered in the item files 130 of the test plan template 110.

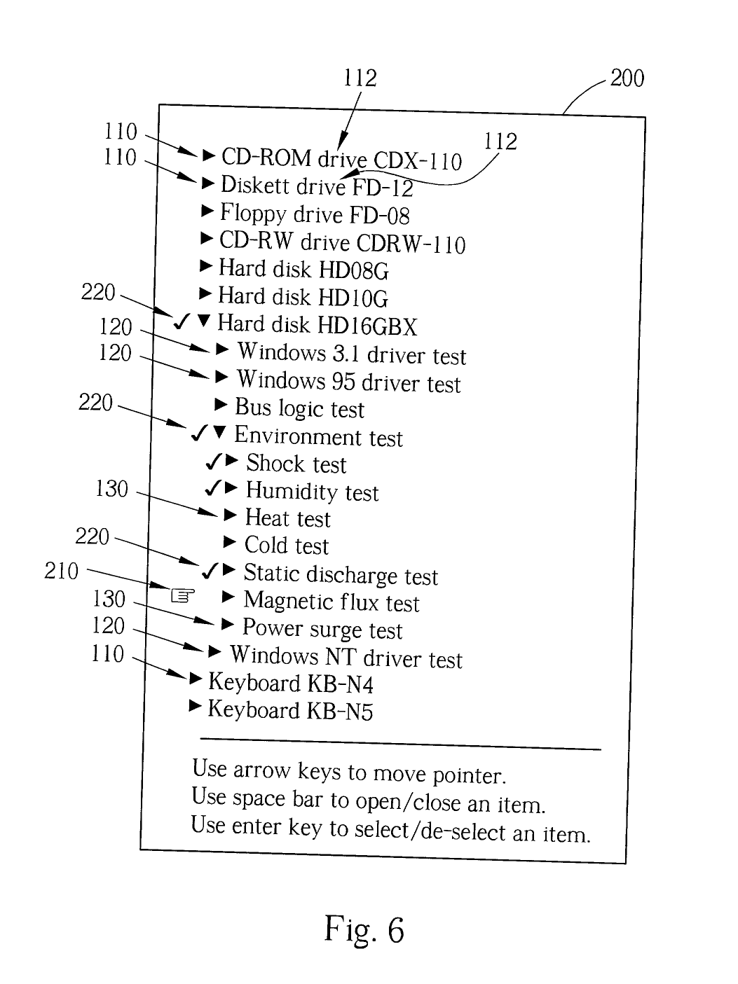

A browser must also be provided that enables a user to view the test plan template archive 100 and to select items from the template archive 100. Please refer to FIG. 6 in conjunction with FIG. 5. FIG. 6 is an example of a browser 200 of the present invention being used to browse the template archive 100. If the template archive 100 is for, say, an manufacturer of electronics goods, then, when using the browser 200 to view the template archive 100, one may see the test plans for a variety of electronic products, such as hard disks, CD-ROM disks, etc. The names 112 are used to display each template test plan 110 in the browser 200. By “opening” a template test plan 110, the user may see the sub-processes 120 of the template 110. These sub-processes 120 are displayed slightly indented in from their related template name 112. And again, by “opening” a sub-process 120, the user may view the item files 130 under the related sub-process 120. The item files 130 are displayed slightly indented in from their related sub-process 120. By “opening” an item file 130, the user may view the internal contents of the item file 130. This is not indicated in FIG. 6, but the result would be much like that presented in FIG. 3. By moving a pointer 210 up and down the user may open, close and select displayed items 110, 120 or 130. Selected items are indicated by check marks 220, and may also be de-selected by the user. Of course, the above is given only as an example. The exact method implemented for a user interface is relatively unimportant so long as the user is able to browse and select, at least, item files 130. By using the browser 200 to browse the template archive 100 and select items, the user creates a hierarchical selection list having a tree-like structure. That is, a selected test plan template 110 will have under it at least one selected sub-process 120, and this selected sub-process 120 will have under it at least one selected item file 130. Items may be “intrinsically” selected by the browser 200. For example, if the user selects an item file 130, the browser 200 may automatically select the parent sub-process 120 of the item file 130, and automatically select the template test plan 110 of the automatically selected sub-process 120.

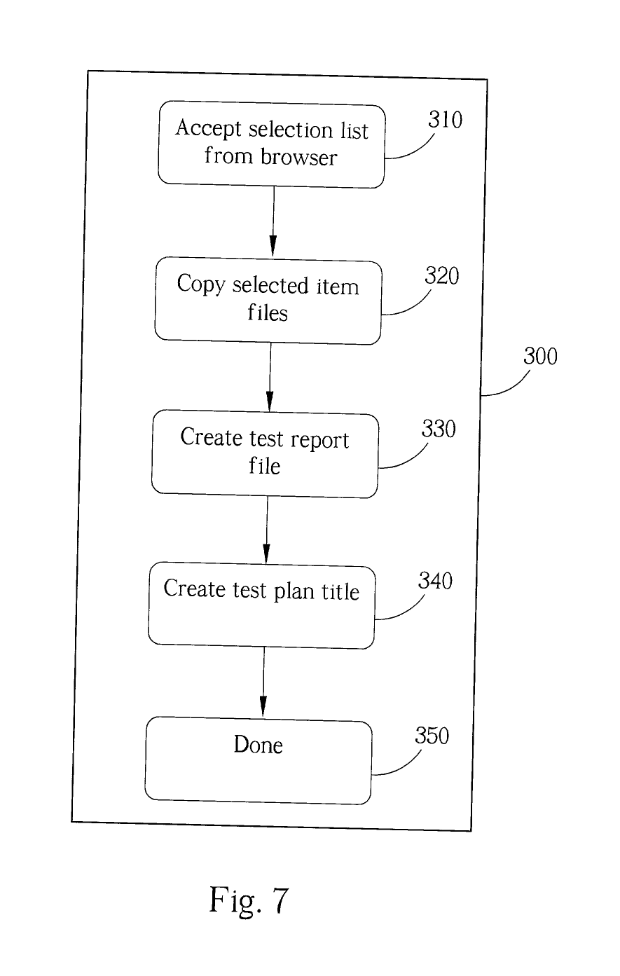

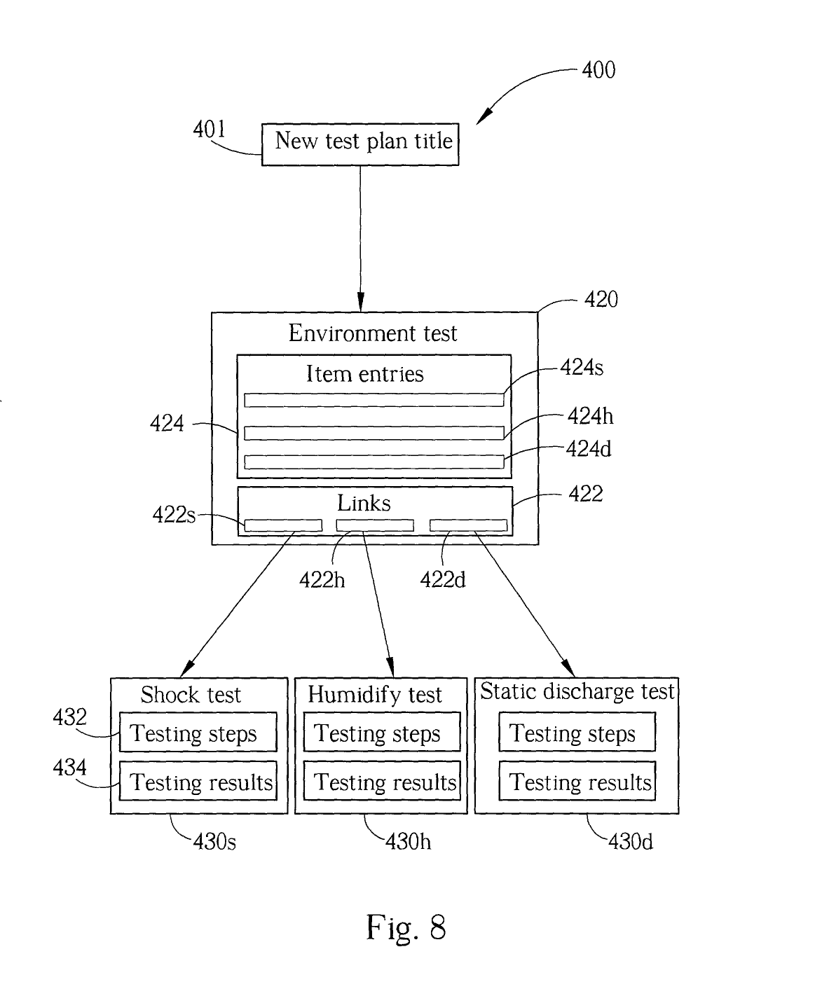

A conversion system must then be provided that converts selected items in the browser 200 into a new test plan. Please refer to FIG. 7 with reference to FIGS. 1, 5 and 6. FIG. 7 is a flow chart for a conversion system 300 of the present invention. The conversion system 300 must perform the following steps, the order of which is relatively unimportant:

Step 310: Accept from the browser 200 those items which have been selected by the user. Of key importance to this invention is that the conversion system 300 accept the item files 130 that have been selected by the user. As each item file 130 has a parent sub-process 120, the conversion system 300 may automatically assume that sub-processes 120 having selected item files 130 are also intrinsically selected, though the user may not have explicitly selected them.

Step 320: Copy the selected item files 130 to create test item files 30 of the new test plan. As the item files 130 are essentially complete in testing detail and instruction, their content need only be extracted from the template archive 100 to create proper test item files 30 for the new test plan. Such extraction may include data decompression and decoding, which are well known in the art of database management.

Step 330: For each selected (either intrinsically or explicitly) sub-process 120, create a test report file 20 for the new test plan. Each new test report file 20 may have the same name as the selected sub-process 120 from which it was derived, and should have links 22. Each link 22 links to a test item file 30, and ensures that the hierarchical tree-like structure of the selected items in the browser 200 is maintained in the new test plan. Item entries 24 are also inserted into each test report file 20, each item entry 24 corresponding to a linked test item file 30 of the test report file 20.

Step 340: Create the top level 12 test plan title. The user may be prompted to supply an appropriate title for the new test plan. This new title is then associated with the newly-created test report files 20. The new title of the top level 12 can then be used to reference the test report files 20.

Step 350: The conversion process is complete.

To better understand the above, please refer to FIG. 8 with reference to FIGS. 6 and 7. FIG. 8 is a block diagram of a new test plan 400 according to the present invention. The new test plan 400 is made from the conversion system 300 based upon selected items shown in FIG. 6. Item files 130 “Shock test”, “Humidity test” and “Static discharge test” are shown selected in FIG. 6. These item files 130 are copied to create the new test item files 430s, 430h and 430d of the new test plan 400. Each test item file 430s, 430h and 430d has testing steps 432 and entries for testing results 434, both of which were present and copied from their respective item files 130. The selected item files 130 were under the sub-process 120 named “Environment test”. The conversion system 300 thus creates a new test report file 420, named “Environment test”. The conversion system 300 then places links 422 and item entries 424 into the new test report file 420. The links 422 include link 422s that links to the test item file 430s, 422h that links to the test item file 430h, and link 422d that links to test item file 430d. The item entries 424s, 424h and 424d are for the test item files 430s, 430h and 430d, respectively. As described previously, the item entries 424 are used as quick references to note the testing status of the test item files 430s, 430h and 430d. Finally, the conversion system 300 prompts the user to provide a title 401 for the new test plan 400, and then associates the test report file 420 with this new title 401. Note that the hierarchical structure of the new test plan 400 corresponds to the hierarchical structure of the items selected in the browser 200.

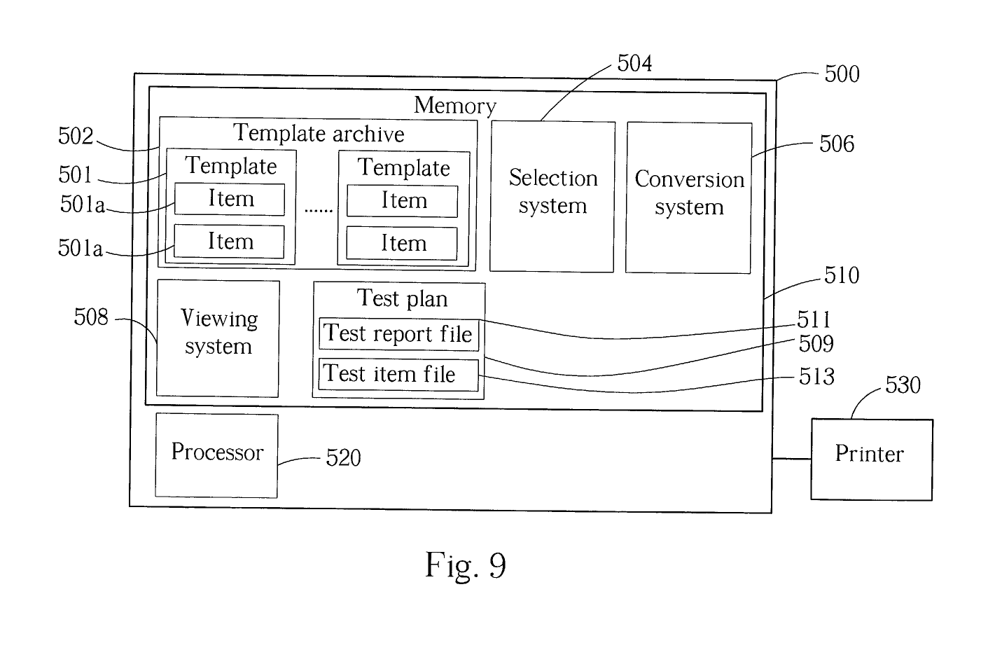

Please refer to FIG. 9. FIG. 9 is a block diagram of a computer system 500 that is used to generate a test plan for a quality control procedure according to the present invention. The computer system 500 includes a processor 520 and a memory 510. The memory 10 could be working memory for the processor 520, or permanent storage memory, such as a magnetic or optical media. A printer 530 is in communications with the computer system 500 and is used to print out documents. The memory 510 includes a template archive 502, a selection system 504, a conversion system 506, a viewing system 508 and a test plan 509. The viewing system 508, selection system 504 and conversion system 506 are executed by the processor 520 to implement the present invention. The template archive 502 is a database that holds a plurality of templates 501, the form and function of which was discussed with reference to FIG. 5. The selection system 504 allows a user to view and select items 501a (such as a sub-process or item file) from at least one template 501 in the template archive 502, as was discussed above with reference to FIG. 6. The conversion system 506 inputs the selected items 101a from the selection system 504 and converts them into an appropriate test plan 509, which has a form and function as was discussed in reference to FIG. 1 and FIG. 7. Most notably, the test plan 509 will have a hierarchical arrangement of test report files 511 and a test item files 513. Finally, the viewing system 508 allows the user to view and edit the test report files 509 and test item files 513. The printer 530 allows the user to print out test report files 511 and test item files 513.

When a user uses the viewing system 508 to view a test report file 511, the links within the test report file 511 are presented as hyperlinks to the user. When the user clicks on this hyperlink, the viewing system will open and present to the user the test item file 513 to which the hyperlink references. In this manner, the user may quickly browse through both test report files 511 and test item files 513.

In a preferred embodiment of the computer system 500, the template archive 502, selection system 504, conversion system 506, viewing system 508 and test plan 509 are all made available on a database of a distributed network. Test plans 509 may thus be easily and instantly accessed by a plurality of users and programs across the network. Thus, if at any time quality control personnel require the test plan 509, they do not need to look for a hardcopy document, but may simply log on to the network and access and edit the test plan 509.

In contrast to the prior art, the present invention provides a system and method that helps to automate the design of quality control test plans. The present invention provides a database of test plan templates, and a selection system that allows a user to select individual components within the test plan templates. The selected components are then converted into a new test plan, which can either be printed or accessed from a computer system. By placing this system on a computer network, quality control personnel across the network may view and edit test plans. Furthermore, as test report files within the test plans are created by a conversion system, they can be made to have a predetermined format. This format, in turn, can be more easily integrated with other software, allowing third-party programs to easily extract pertinent information from the test report files.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for generating a test plan for a quality control procedure, the test plan having a hierarchical structure comprising:
a first top level identifying the test plan;
a first intermediate level comprising at least a test report file of the test plan; and
a first lower level comprising at least a test item file for each test report file, each test item file comprising testing steps for performing a test of an item;
wherein the first top level is used to access the associated test report files of the test plan, and each test report file is used to access the associated test item files;
the method comprising:
providing a template archive, the template archive comprising at least a template, each template having a hierarchical structure comprising:
a second top level for identifying the template;
a second intermediate level for identifying at least a sub-process of the template; and
a second lower level comprising at least a template item file for each sub-process, each template item file comprising testing steps for performing a test of an item;
wherein the second top level is used to access the associated sub-processes of the template, and each sub-process is used to access the associated template item files;
providing a selection system, the selection system enabling a user to select a template from the template archive, select a sub-process from the template, and select a template item file from the sub-process; and
providing a conversion system that converts the selected template, sub-process, and template item file into a corresponding test plan;
wherein the user uses the selection system to create a hierarchical selection list by selecting a template, at least a sub-process of the template, and at least a template item file for each selected sub-process, and the conversion system creates a product test plan according to the selection list, the product test plan having a corresponding test report file for each selected sub-process, and a corresponding test item file for each selected template item file, the hierarchical structure of the product test plan conforming to the hierarchical structure of the selection list.

2. The method of claim 1 wherein the hierarchical structure of the product test plan is a tree structure.

3. The method of claim 1 wherein the conversion system copies the contents of each selected template item file to create the test item files of the product test plan.

4. The method of claim 1 wherein the conversion system creates a test report file for each selected sub-process.

5. The method of claim 4 wherein the conversion system places at least a link in the test report file, each link being used to access a test item file.

6. A system for generating a test plan for a quality control procedure, the test plan having a hierarchical structure comprising:
a first top level identifying the test plan;
a first intermediate level comprising at least a test report file of the test plan; and
a first lower level comprising at least a test item file for each test report file, each test item file comprising testing steps for performing a test of an item;
wherein the first top level is used to reference the associated test report files of the test plan, and each test report file is used to reference the associated test item files;
the system comprising:
a template archive, the template archive comprising at least a template, each template having a hierarchical structure comprising:
a second top level for identifying the template;
a second intermediate level for identifying at least a sub-process of the template; and
a second lower level comprising at least a template item file for each sub-process, each template item file comprising testing steps for performing a test of an item;
wherein the second top level is used to reference the associated sub-processes of the template, and each sub-process is used to reference the associated template item files;
a selection system, the selection system enabling a user to select a template from the template archive, select a sub-process from the template, and select a template item file from the sub-process; and
a conversion system that converts the selected template, sub-process, and template item file into a corresponding test plan;
wherein the user uses the selection system to create a hierarchical selection list by selecting a template, at least a sub-process of the template, and at least a template item file for each selected sub-process, and the conversion system creates a product test plan according to the selection list, the product test plan having a corresponding test report file for each selected sub-process, and a corresponding test item file for each selected template item file, the hierarchical structure of the product test plan conforming to the hierarchical structure of the selection list.

7. The system of claim 6 wherein the template archive is stored on a computer system.

8. The system of claim 7 wherein the hierarchical structure of the product test plan is a tree structure.

9. The system of claim 8 wherein the conversion system copies the contents of each selected template item file to create the test item files of the product test plan.

10. The system of claim 7 wherein the conversion system creates a test report file for each selected sub-process.

11. The system of claim 10 wherein the conversion system places at least a link in the test report file, each link being used to access a test item file.

12. The system of claim 11 further comprising a viewing system that enables the user to view at least a test report file or at least a test item file.

13. The system of claim 12 wherein when the user views a test report file, the links in the test report file are presented as hyperlinks, and each hyperlink enables the user to instruct the viewer to present the associated test item file.

14. The system of claim 7 further comprising a printing system that enables the user to print at least a test report file or at least a test item file.
